(19) United States
(12) Patent Application Publication
(10) Pub. No.: US 2009/0095095 A1
(43) Pub. Date: Apr. 16, 2009

(54) MICROSTRUCTURE INSPECTING APPARATUS, MICROSTRUCTURE INSPECTING METHOD AND SUBSTRATE HOLDING APPARATUS

(75) Inventors: Masato Hayashi, Tokyo (JP); Hisashi Fujiwara, Tokyo (JP); Kazuki Amemiya, Tokyo (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/298,359

(22) PCT Filed: Oct. 31, 2007
(86) PCT No.: PCT/JP2007/071244

§ 371 Date: Oct. 24, 2008

(30) Foreign Application Priority Data
Nov. 2, 2006 (JP) 2006-299485

(51) Int. Cl. G01M 19/00

(52) U.S. Cl. 73/865.8

(57) ABSTRACT

An inspecting apparatus of a microstructure having a movable section 16a with its both sides supported includes a chuck top 9 for holding a wafer 8 in which the microstructure is formed so as to make a main surface of the wafer 8 into a convexly or concavely curved shape having a nearly uniform curvature radius. The apparatus includes a shape changing unit for changing the curvature radius of the shape of the main surface of the wafer 8. The shape changing unit is a temperature controlling unit for changing a shape of a top surface of a chuck top 9, on which the substrate is mounted, according to a temperature. A transfer tray whose top surface, on which the wafer 8 is mounted, formed into a convexly or concavely curved shape may be interposed between the wafer 8 and the chuck top 9 whose top surface is flat.

### TECHNICAL FIELD

The present invention relates to an inspecting apparatus and method for inspecting a microstructure such as MEMS (Micro Electro Mechanical Systems) and an apparatus for holding a substrate on which the microstructure is formed.

### BACKGROUND ART

Recently, MEMS devices, which integrate various mechanical, electronic, optical and chemical functions by using a semiconductor microfabrication technology or the like, are attracting attention. As examples of MEMS technology that have been in practical use, there are sensors used in an automobile or a medical field, and the MEMS devices are installed in microsensors such as an acceleration sensor, a pressure sensor, an air flow sensor or the like. Further, an application of the MEMS technology to an inkjet printer head has enabled an increase of the number of nozzles for jetting ink and an improvement of ink jetting accuracy, which in turn allows an enhancement of image quality and printing speed. Further, a micro mirror array or the like used in a reflective type projector is also known as a general MEMS device.

Further, it is expected that development of various sensors or actuators using the MEMS technology will expand application range of the MEMS devices to an optical communication/mobile device, a peripheral device of a calculator, a bio-analysis system, a mobile power source, and so forth.

Meanwhile, with the development of the MEMS devices, a method for properly inspecting the MEMS devices is also getting important especially because the MEMS devices are formed of microstructures. Conventionally, evaluation on device characteristics of the MEMS devices has been performed after packaging the MEMS devices, by way of rotating or vibrating the MEMS devices for every package. However, it is more desirable to detect defects of the devices by performing an appropriate inspection at an early stage such as in a wafer state after a microfabrication process, thereby raising the production yield while reducing the manufacturing costs.

When inspecting the MEMS devices in the wafer state, it is desirable to uniformly maintain a fixed condition or a stress condition of each chip of the MEMS devices. For example, if there is a chip which is not in contact with a mounting table since the wafer warps or if a part of the wafer receives a flexural stress since there is a change in shape of a chuck top for holding the wafer, it is impossible to inspect each of the chips under the same conditions.

Here, a method for correcting a warp of the wafer or for applying a stress to the wafer has been suggested. For example, Patent Document 1 or Patent Document 3 discloses a technique for inspecting electrical properties of a chip with a high accuracy even while the wafer is being warped.

A technique of Patent Document 1 includes a pressing means formed on a lower surface of a probe card. Accordingly, when a probe is brought into contact with a wafer, a good contact state can be obtained by interposing a pressing jig so as to press a peripheral area of an inspection target chip onto a chuck table. Patent Document 3 discloses that plural contact pins are installed on a stage and are selectively pressed by movable contact pieces, so that the contact pins are brought into contact with a rear surface of a semiconductor wafer at specified positions corresponding to the contact pieces.

Further, Patent Document 2 discloses a method for applying a compressive stress to a wafer. Patent Document 2 discloses that a screw of a compressive-stress generation mechanism installed in a lower part of a semiconductor wafer is turned and brought into slight contact with a rear surface of the held semiconductor wafer. Accordingly, by turning the screw, the compressive stress according to its rotation angle and its screw pitch is applied quantitatively to the semiconductor wafer.

In addition, a method for adsorptively holding the wafer horizontally is disclosed in, for example, Patent Document 4 or Patent Document 5. Patent Document 4 discloses that a cylindrical supporting column installed on a wafer stage is moved vertically according to a warp of the wafer or a foreign substance on a rear surface of the wafer so as to set a wafer sucking surface. Further, Patent Document 5 discloses that fluid is introduced into a recessed part which is not in contact with a wafer of a chuck main body, thereby correcting a warp of the wafer, which is caused by its own weight and directed toward a bottom surface of the recessed part.

Patent Document 1: Japanese Patent Laid-open Application No. H5-288802
Patent Document 2: Japanese Patent Laid-open Application No. H5-343504

### Patent Document 3: Japanese Patent Laid-open Application No. 2004-311799

Patent Document 4: Japanese Patent Laid-open Application No. H6-169007
Patent Document 5: Japanese Patent Laid-open Application No. H9-266242

### DISCLOSURE OF THE INVENTION

### Problems to Be Solved by the Invention

When inspecting characteristics of a MEMS device having a microscopic movable section, a physical stimulus needs to be applied to the MEMS device from the exterior. In general, a structure having a microscopic movable section such as an acceleration sensor is a device whose response characteristic varies even for a microscopic movement. Accordingly, a highly accurate inspection is required to be performed to evaluate the characteristics of the MEMS device. Further, it is desirable to perform the inspection while not in contact with the movable section of the device.

For example, as a method for inspecting the acceleration sensor, i.e., one of the MEMS devices, in a wafer state, there is proposed a method of detecting a movement of the movable section by applying a sound wave to the movable section of the sensor. Besides, there are proposed a method of applying vibration to the whole wafer, a method of measuring a change in a gravity direction by tilting the wafer, a method of mechanically vibrating the movable section of the sensor, a method of making a displacement of the movable section by injecting fluid into the movable section of the sensor, and the like.

If a warp of the wafer has an effect on a vibration mode of the movable section depending on a film formation structure of the wafer and a shape of the chuck top since, e.g., both sides of the microstructure are supported by two beams, it may be possible for the movable section not to vibrate even if vibration caused by any external factor is applied or it may be impossible to perform a normal test since the vibration is too small. Further, even if the warp of the wafer is corrected to inspect each of the chips in a flat state, there is likelihood that a microscopic film formation abnormality in the beam structure cannot be detected.

In accordance with Patent Document 2, a stress applied onto each chip varies according a shape of the wafer (typically, circular shape). Further, it can be expected that even in case the wafer is warped, various stresses are applied onto each of the chips.

In view of the foregoing, the present invention provides an inspecting apparatus capable of performing a dynamic test of the characteristic of the microstructure having the movable section, whose both sides are supported, in a wafer state with a high accuracy.

### Means for Solving the Problems

In accordance with a first aspect of the present invention, an inspecting apparatus of a microstructure having a movable section with its both sides supported includes a substrate holding unit for holding a substrate in which the microstructure is formed so as to make a main surface of the substrate into a convexly or concavely curved shape having a nearly uniform curvature radius.

The microstructure inspecting apparatus further includes a shape changing unit for changing the curvature radius of the shape of the main surface of the substrate.

In particular, the shape changing unit is a temperature controlling unit for changing a shape of a top surface of a chuck top, on which the substrate is mounted, according to a temperature.

It is desirable that the substrate holding unit includes a chuck top whose top surface, on which the substrate is mounted, is formed into a convexly or concavely curved shape.

It may be possible that the substrate holding unit includes a transfer tray whose top surface, on which the substrate is mounted, is formed into a convexly or concavely curved shape.

In accordance with a second aspect with the present invention, a method for inspecting a microstructure having a movable section with its both sides supported includes measuring characteristics of the microstructure while maintaining a substrate so as to make a main surface of the substrate, in which the microstructure is formed, into a convexly or concavely curved shape having a nearly uniform curvature radius.

The microstructure inspecting method further includes changing the curvature radius of the shape of the main surface of the substrate.

It is desirable that the microstructure inspecting method includes adsorbing and holding the substrate on a chuck top whose top surface, on which the substrate is mounted, is formed into a convexly or concavely curved shape.

It may be possible that a transfer tray whose top surface, on which the substrate is mounted, is formed into a convexly or concavely curved shape is interposed between the substrate and the chuck top so as to adsorb and hold the substrate.

In accordance with a third aspect of the present invention, a substrate holding apparatus holds a substrate, in which a microstructure having a movable section with its both sides supported is formed, so as to make a main surface of the substrate into a convexly or concavely curved shape having a nearly uniform curvature radius.

The substrate holding apparatus includes a shape changing unit for changing the curvature radius of the shape of the main surface of the substrate.

It is desirable that the substrate holding apparatus is a chuck top whose top surface, on which the substrate is mounted, is formed into a convexly or concavely curved shape.

It is also desirable that the substrate holding apparatus holds the substrate by a vacuum-adsorption, and a vacuum-adsorbing groove formed on the top surface of the chuck top on which the substrate is mounted is formed to be contact with a portion not corresponding to the movable section of the microstructure of the substrate.

It may be possible that a high porosity layer is formed on the top surface of the chuck top on which the substrate is mounted.

It is desirable that the high porosity layer is formed on the top surface of the chuck top on which the substrate is mounted to be in contact with a portion not corresponding to the movable section of the microstructure of the substrate.

It may be possible that the substrate holding apparatus includes a transfer tray whose top surface, on which the substrate is mounted, is formed into a convexly or concavely curved shape.

It is desirable that the substrate holding apparatus holds the substrate by a vacuum-adsorption, and a vacuum-adsorbing groove formed on the top surface of the transfer tray on which the substrate is mounted is formed to be contact with a portion not corresponding to the movable section of the microstructure of the substrate.

Further, the substrate holding apparatus holds the substrate by a vacuum-adsorption, and a high porosity layer is formed on the top surface of the transfer tray on which the substrate is mounted.

It is desirable that the high porosity layer is formed on the top surface of the transfer tray on which the substrate is mounted to be in contact with a portion not corresponding to the movable section of the microstructure of the substrate.

### EFFECT OF THE INVENTION

The microstructure inspecting apparatus and the microstructure inspecting method in accordance with the present invention are capable of normally inspecting the microstructure having the movable section, whose both sides are supported, in a wafer state and improving an S/N ratio of an inspected signal since it is possible to obtain an electrical variation in a large degree.

### BRIEF DESCRIPTION OF THE DRAWINGS

FIG. 1 is a schematic configuration view of a microstructure inspecting apparatus in accordance with an embodiment of the present invention;

FIG. 2 sets forth a block diagram illustrating a configuration of an inspection control unit and a prober unit of the inspecting apparatus of FIG. 1;

FIG. 3 presents a top view of a triple-axis acceleration sensor;

FIG. 4 is a schematic configuration view of the triple-axis acceleration sensor;

FIG. 5 illustrates strains of weight bodies and beams when acceleration is applied in each axial direction;

FIGS. 6A and 6B are circuit diagrams of Wheatstone bridges installed on each circuit;

FIGS. 7A to 7C present an output response of the triple-axis acceleration sensor with respect to an inclination angle;

FIG. 8 offers a relationship between a gravitational acceleration (input) and an output of the sensor;

FIG. 9 illustrates a conceptual view illustrating a structure of the inspection in accordance with an embodiment of the present invention;

FIG. 10 presents a cross-sectional view showing a structure for holding a substrate in the inspecting apparatus in accordance with an embodiment of the present invention;

FIG. 11 offers a cross-sectional view showing a wafer which is deformed to be convexly curved upward;

FIG. 12 illustrates a cross-sectional view of a wafer which is deformed to be concavely curved upward;

FIG. 13 is a graph showing a relationship between a substrate shape and a resonant frequency of the acceleration sensor;

FIG. 14 presents a cross-sectional view showing a configuration example in which a tray is employed in a wafer holding structure;

FIG. 15 depicts a wafer holding structure in accordance with a second modification example of a first embodiment of the present invention;

FIG. 16 depicts a wafer holding structure in accordance with a third modification example of the first embodiment of the present invention;

FIG. 17 is a plane view showing an example position of hollow portions of a wafer;

FIG. 18 is a plane view showing an example of a shape of a vacuum groove on a top surface of a tray;

FIGS. 19A and 19B provide conceptual configuration views to illustrate an example of a pressure sensor;

FIG. 20 sets forth a flowchart to describe an example operation of the inspecting apparatus in accordance with the present invention;

FIG. 21 illustrates a cross-sectional shape of a chuck top when a wafer in a convexly curved shape;

FIG. 22 is a graph to provide a measurement result of a response of an acceleration sensor when the wafer is adsorbed by using the chuck top of FIG. 21;

FIG. 23 illustrates a cross-sectional shape of the chuck top when the wafer is in a concavely curved shape; and

FIG. 24 is a graph to provide a measurement result of a response of the acceleration sensor when the wafer is adsorbed by using the chuck top of FIG. 23.

### EXPLANATION OF CODES

1 Inspecting apparatus
2 Inspection control unit
3 Chuck top temperature control unit (Temperature control means)
4 Probe card
4a Probe
8 Wafer (Substrate)
9 Chuck top (Substrate holding means)
16 Acceleration sensor (Microstructure)
16a Movable section
17 Tray (Substrate holding means)
17a Connecting pipe
17b High porosity layer
17c Vacuum groove
18 Planar substrate
91 Vacuum groove
AR Weight body (Movable section)
BM Beams (Movable section)
TP Chip (Microstructure)

### BEST MODE FOR CARRYING OUT THE INVENTION

Hereinafter, embodiments of the present invention will be described in detail with reference to the accompanying drawings. In the accompanying drawings, like reference numerals designate like parts or corresponding parts and the explanation thereof will not be repeated.

### First Embodiment

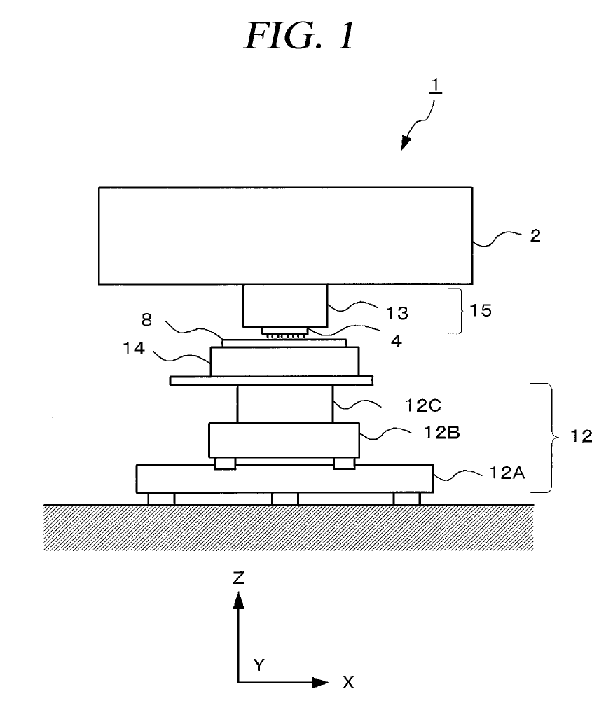

FIG. 1 provides a schematic configuration view of an inspecting apparatus 1 in accordance with an embodiment of the present invention. As shown in FIG. 1, the inspecting apparatus 1 includes a loader unit 12 for transferring a test target object, for example, a wafer 8; a prober unit 15 for performing an inspection of electrical characteristics of the wafer 8; and an inspection control unit 2 for measuring characteristic values of an acceleration sensor, which is provided on the wafer 8, by the prober unit 15.

The loader unit 12 includes a mounting member (not shown) for mounting thereon a cassette accommodating, e.g., twenty five sheets of wafers 8; and a wafer transfer mechanism for transferring the wafers 8 from the cassette of the mounting member sheet-by-sheet.

The wafer transfer mechanism has a main chuck 14 moving along three axial directions (i.e., X-, Y- and Z-axis directions) by X, Y and Z tables 12B, 12A and 12C which function as moving mechanisms in three orthogonal axes of X, Y and Z, respectively. The main chuck 14 is provided to rotate the wafer 8 around the Z axis. To elaborate, the wafer transfer mechanism includes the Y table 12A moving along the Y direction, the X table 12B moving on the Y table 12A along the X direction; and the Z table 12C moving up and down along the Z direction, where the Z table 12C is disposed such that its axial center is aligned to be coincident with the center of the X table 12B. The main chuck 14 is moved in the X, Y and Z directions by the X table 12B, the Y table 12A and the Z table 12C, respectively. Further, the main chuck 14 is rotated in forward and backward directions within a predetermined range by a rotation driving mechanism rotating around the Z axis.

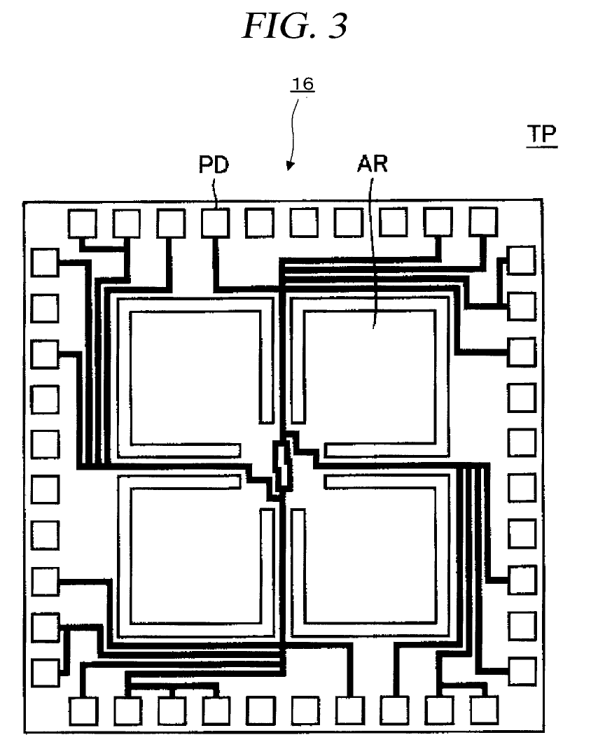

The prober unit 15 includes a probe card 4 and a probe control unit 13 for controlling the probe card 4. The probe card 4 includes testing probes 4a which are brought into contact with electrode pads PD (see FIG. 3) formed on the wafer 8 and made of a conductive metal such as copper, a copper alloy, aluminum or the like. When the probes 4a and the electrode pads PD come into contact with each other, a contact resistance therebetween is reduced by a fritting phenomenon, i.e., one of an electrical break down of an insulating film, so that they are allowed to be electrically connected with each other.

The fritting phenomenon refers to a phenomenon in which, when a potential gradient applied to an oxide film formed on a surface of a metal (electrode pad PD in the present invention) becomes about 10⁵ to 10⁶ V/cm, an electric current flows due to a non-uniformity in a thickness of the oxide film or a composition of the metal, thereby breaking down the oxide film. A voltage is applied between a pair of the probes 4a brought into contact with the electrode pad PD. As the voltage is gradually increased, the oxide film between the pair of the probes 4a and the electrode pad PD is destroyed so that a current flows, thereby reducing a contact resistance between the probes 4a and the electrode pad PD so as to be electrically connected with each other.

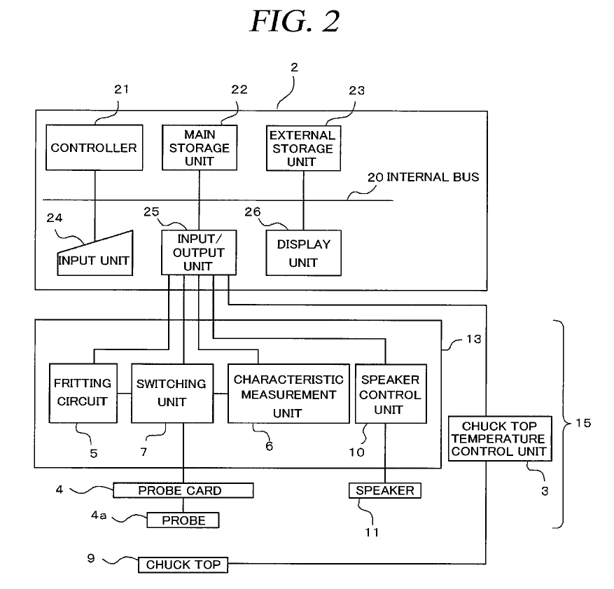

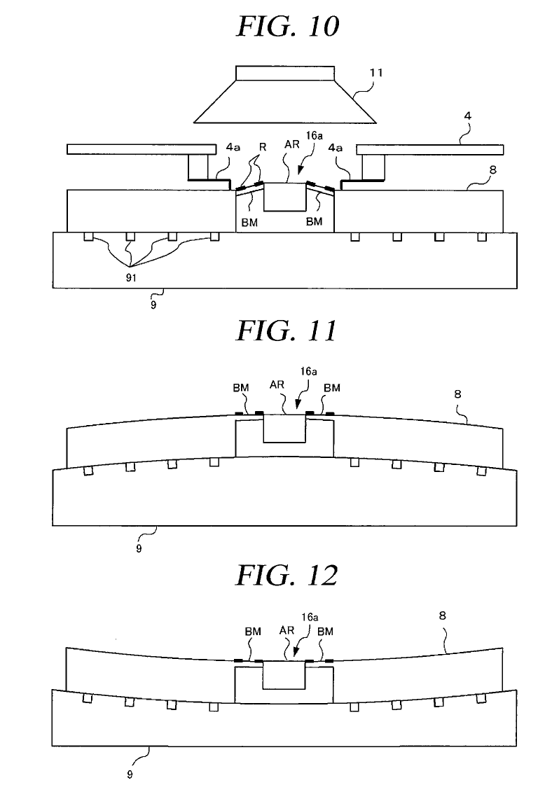

The prober unit 15 includes a speaker 11 (see FIG. 2) for applying a sound wave to a movable section 16a (see FIG. 10) of an acceleration sensor 16 (see FIG. 3) formed on the wafer 8. The probe control unit 13 controls the probes 4a of the probe card 4 and the speaker 11, and applies a certain displacement to the acceleration sensor 16 formed on the wafer 8 and then detects a movement of the movable section 16a of the acceleration sensor 16 as an electric signal through the probes 4a.

The prober unit 15 measures characteristic values of the acceleration sensor 16 formed on the wafer 8 by allowing the probes 4a of the probe card 4 and the electrode pads PD on the wafer 8 to come into electrical contact with each other.

FIG. 2 is a block diagram illustrating configurations of the inspection control unit 2 and the prober unit 15 of the inspecting apparatus 1. The inspection control unit 2 and the prober unit 15 constitute an acceleration sensor evaluation and measurement circuit.

As shown in FIG. 2, the inspection control unit 2 includes a controller 21, a main storage unit 22, an external storage unit 23, an input unit 24, an input/output unit 25 and a display unit 26. The main storage unit 22, the external storage unit 23, the input unit 24, the input/output unit 25 and the display unit 26 are all connected to the controller 21 via an internal bus 20.

The controller 21 includes a CPU (Central Processing Unit) or the like, and it performs a process for measuring characteristics of a sensor on the wafer 8, for example, a resistance value of a resistor, a current or a voltage of a circuit constituting the sensor, and the like according to a program stored in the external storage unit 23.

The main storage unit 22 includes a RAM (Random-Access Memory) or the like, and loads therein the program stored in the external storage unit 23 and is used as a working area of the controller 21.

The external storage unit 23 includes a nonvolatile memory such as a ROM (Read Only Memory), a flash memory, a hard disk, a DVD-RAM (Digital Versatile Disc Random-Access Memory), a DVD-RW (Digital Versatile Disc Rewritable), or the like, and pre-stores therein the program required to allow the process to be carried out by the controller 21. Further, in response to a command from the controller 21, the external storage unit 23 supplies data stored by the program to the controller 21, and also stores therein data sent from the controller 21.

The input unit 24 includes a keyboard, a pointing device such as a mouse, and an interface device for connecting the keyboard and the pointing device to the internal bus 20. The start of evaluation and measurement, the selection of a measurement method, or the like is inputted through the input unit 24 and is sent to the controller 21.

The input/output unit 25 includes a serial interface or a LAN (Local Area Network) interface connected to the probe control unit 13 which is under the control of the inspection control unit 2. Through the input/output unit 25, instructions upon a contact of the probes 4a with the electrode pads PD of the wafer 8; an electrical conduction therebetween; a switching operation thereof; a control of a sound wave emitted to the movable section 16a of the acceleration sensor 16; and the like are transmitted to the probe control unit 13. Further, the measured results are inputted thereto.

The display unit 26 has a CRT (Cathode Ray Tube), an LCD (Liquid Crystal Display), or the like, and displays thereon, for example, a frequency response characteristic which is the measured result.

The probe control unit 13 includes a speaker control unit 10, a fritting circuit 5, a characteristic measurement unit 6 and a switching unit 7. The characteristic measurement unit 6 supplies the probe card 4 with a power for measuring an electric signal of the acceleration sensor 16, and measures a current flowing in the acceleration sensor 16, a voltage between terminals, and so forth.

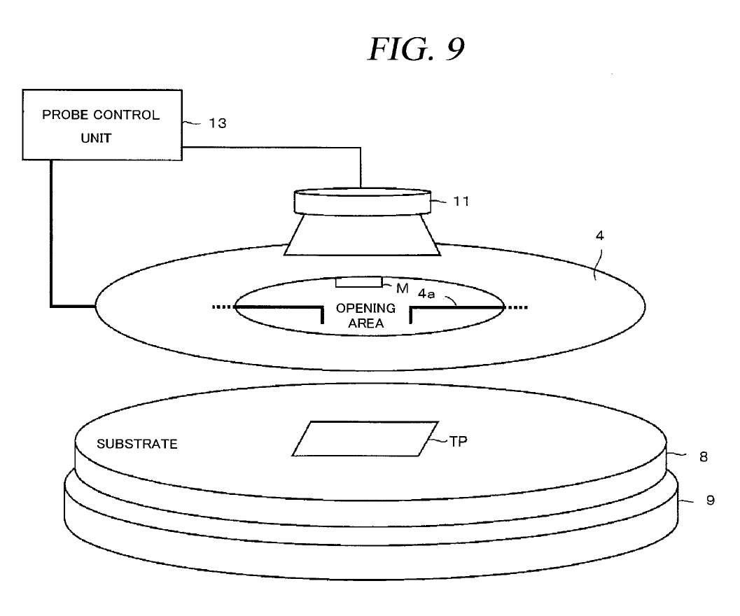

The speaker control unit 10 controls the frequency and the sound pressure of the sound wave emitted from the speaker 11 to make a displacement to the movable section 16a (see FIG. 9) of the acceleration sensor 16 formed on the wafer 8. By controlling the sound wave emitted from the speaker 11, a certain displacement is applied to the movable section 16a of the acceleration sensor 16.

The fritting circuit 5 is a circuit which supplies electric currents to the probes 4a of the probe card 4 in contact with the electrode pads PD of the wafer 8, and generates a fritting phenomenon between the probes 4a and the electrode pads PD to thereby reduce the contact resistance therebetween.

The inspection control unit 2 evaluates the microstructure by using the electric current flowing in the acceleration sensor 16, the voltage between the terminals, and the like (characteristics of the microstructure) measured by the characteristic measurement unit 6. The inspection control unit 2, for example, applies a static or dynamic displacement to the movable section 16a and a response of the acceleration sensor 16 is measured by the characteristic measurement unit 6, and the controller 21 of the inspection control unit 2 determines whether the response is within a designed reference range with reference to a table of the external storage unit 23.

The switching unit 7 performs a switching operation to connect each probe 4a of the probe card 4 to either one of the fritting circuit 5 and the characteristic measurement unit 6.

A chuck top temperature control unit 3 controls the temperature of a chuck top 9 holding the wafer 8 to be a predetermined temperature, thereby making a top surface of the chuck top 9 into a desired shape. For example, if the top surface of the chuck top 9 is in a concavely curved shape at room temperature, as the temperature is increased, the curvature radius of the concave top surface becomes larger and the top surface becomes nearly flat (the curvature radius=infinity). Meanwhile, if the top surface is flat at room temperature, as the temperature is increased, the flat top surface becomes a convex curved surface and an absolute value of the curvature radius of the convex curved surface becomes gradually decreased. As described below, the chuck top temperature control unit 3 changes the shape of the wafer 8 by changing the shape of the top surface of the chuck top 9 and controls the compressive and extensive stresses on a both sides supporting structure of the acceleration sensor 16.

Hereinafter, before explaining an inspecting method in accordance with an embodiment of the present invention, a triple-axis acceleration sensor 16 of a microstructure to be inspected will be described first.

FIG. 3 illustrates a top view of the triple-axis acceleration sensor 16. As shown in FIG. 3, a multiplicity of electrode pads PD are disposed on the periphery of a chip TP formed on the wafer 8, and metal interconnections are also provided on the chip TP to transceive electric signals to and from the electrode pads PD. Further, on a central portion of the chip TP, there are arranged four weight bodies AR in a clover shape.

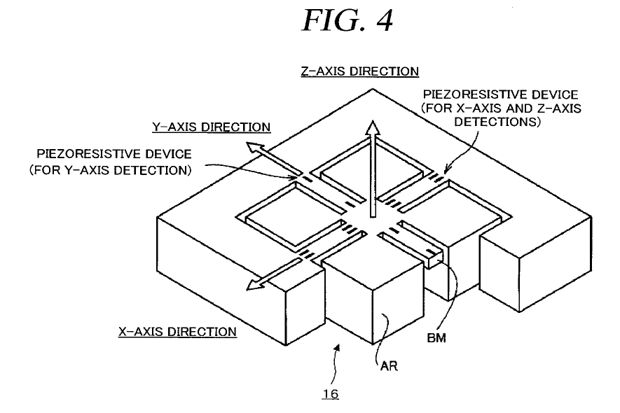

FIG. 4 presents a schematic view of the triple-axis acceleration sensor 16. The triple-axis acceleration sensor 16 is of a piezoresistive type in which piezoresistive devices serving as detecting elements are installed as diffusion resistors. The acceleration sensor 16 of the piezoresistive type can be fabricated through a low-cost IC process. Since the sensitivity of the acceleration sensor does not deteriorate even if the resistor devices, which serve as the detecting elements, are formed small, this type of acceleration sensor is advantageous for device miniaturization and cost reduction.

In accordance with a configuration as shown in FIG. 4, the weight body AR in a central portion is configured as a both sides supporting structure supported by four beams BM. The beams BM are arranged to cross each other perpendicularly in two axial directions, i.e., X- and Y-axis directions, and four piezoresistive devices are provided along each axis. Further, four piezoresistive devices for Z-axis directional detection are disposed beside the piezoresistive devices for the X-axis directional detection. Top surface of the weight body AR forms the clover shape, and it is connected to the beams BM at the central portion thereof. By adopting the clover-shaped structure, the size of the weight body AR and the length of the beams can be expanded, so that a compact high-sensitivity acceleration sensor 16 can be realized.

The operation principle of the piezoresistive type triple-axis acceleration sensor 16 is as follows. If a weight body AR is given an acceleration (force of inertia), the beams BM are strained, and the acceleration is detected based on a variation in resistance values of the piezoresistive devices formed on the surfaces of the beams BM. Sensor outputs are obtained from outputs of Wheatstone bridges independently disposed on each of the three axes.

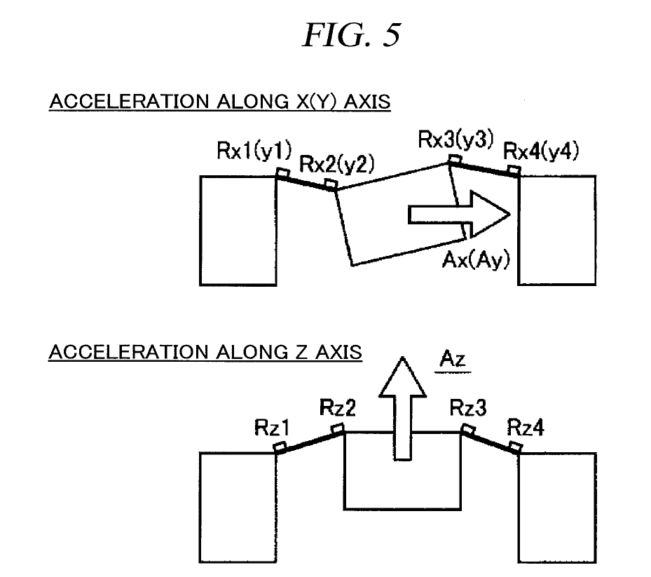

FIG. 5 presents a conceptual diagram to describe a strain of the weight body AR and the beams BM when the acceleration is applied in each axial direction. As illustrated in FIG. 5, a piezoresistive device is characterized in that its resistance value is varied by a strain applied thereto (referred to as a piezoresistive effect). In case of an extension strain, the resistance value increases, while the resistance value decreases in case of a compression strain. In the present embodiment, X-axis directional detection piezoresistive devices (Rₓ1 to Rₓ4), Y-axis directional detection piezoresistive devices (R_{y}1 to R_{y}4) and Z-axis directional detection piezoresistive devices (R_{z}1 to R_{z}4) are provided for illustration.

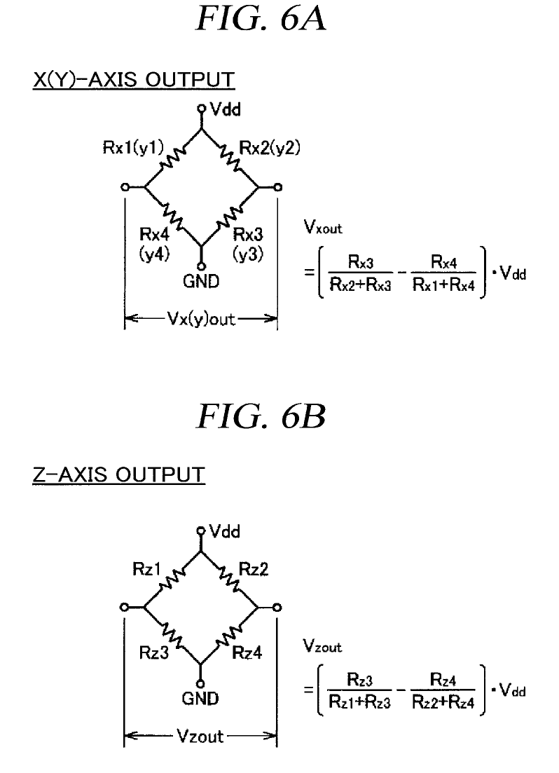

FIGS. 6A and 6B show circuit diagrams of Wheatstone bridges provided on the respective axes. FIG. 6A is a circuit diagram of the Wheatstone bridge on the X (Y) axis. Output voltages of the X and Y axes are set to be Vₓₒᵤₜ and V_{yout}, respectively. FIG. 6B is a circuit diagram of the Wheatstone bridge on the Z axis and an output voltage of the Z axis is set to be V_{zout}.

As described above, due to the inflicted strain, the resistance values of the four piezoresistive devices on each axis are varied. Based on these variations of each piezoresistive device, circuit outputs generated by the Wheatstone bridges on, for example, the X and Y axes, that is, acceleration components of the X and Y axes are detected as independently separated output voltages. Further, like the configuration of the above circuit, metal interconnections as shown in FIG. 3 are connected, so that the output voltage for each axis is detected from a predetermined electrode pad PD.

Further, the triple-axis acceleration sensor 16 is capable of detecting a DC component of the acceleration, so it can be used as an inclined-angle sensor for detecting a gravitational acceleration. In the present embodiment, the acceleration sensor 16 will be described as an example, but the present invention can be applied to any device having the movable section 16a with its both sides supported. Here, the both sides supporting structure refers to a structure for supporting the movable section 16a at both points with respect to the center of the movable section 16a on a line passing through nearly the center of the movable section 16a.

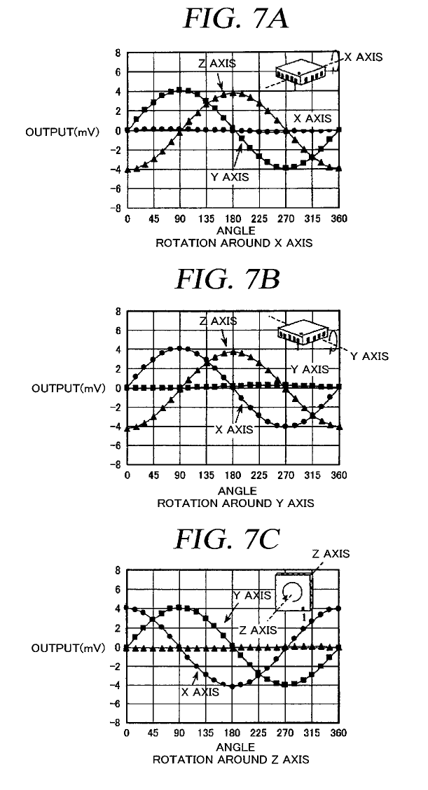

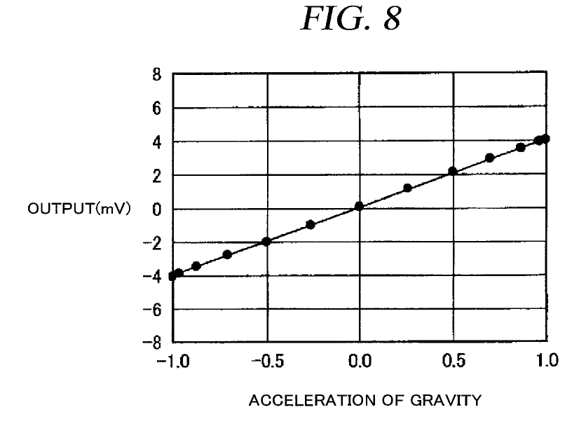

FIGS. 7A to 7C present an output response of the triple-axis acceleration sensor 16 with respect to the inclination angle. As illustrated in FIGS. 7A to 7C, the sensor is rotated around the X, Y and Z axes and bridge outputs of each of the X, Y and Z axes are measured by a digital voltmeter. A low-voltage power source of +5 V is used as a power source of the sensor. Further, each measurement point illustrated in FIGS. 7A to 7C is plotted by using a value obtained by arithmetically subtracting a zero point offset from each axis output.

FIG. 8 offers a relationship between the gravitational acceleration (input) and the output of the sensor. The input/output relationship shown in FIG. 8 is obtained by calculating a gravitational acceleration component related to each of the X, Y and Z-axes from a cosine of the inclination angle of FIGS. 7A to 7C; obtaining a relationship between the gravitational acceleration (input) and the output of the sensor; and then evaluating a linearity of the input and output. That is, the acceleration and the output voltage have a nearly linear relationship therebetween.

Referring again to FIGS. 1 and 2, the microstructure inspecting method in accordance with the embodiment of the present invention is a method in which a test sound wave generated from the speaker 11 is applied to the triple-axis acceleration sensor 16, i.e., the microstructure, so that characteristics of the microstructure are evaluated by detecting movements of the movable section 16a of the microstructure based on the test sound wave.

Now, an evaluation method for the acceleration sensor 16 in accordance with the embodiment of the present invention will be explained.

FIG. 9 illustrates a conceptual configuration view showing an inspection of the acceleration sensor 16. The probe card 4 includes the speaker 11 which serves as a test sound wave outputting unit. The probe card 4 is provided with an opening area at a position corresponding to the test sound wave outputting unit, so that the sound wave from the speaker 11 is allowed to reach the chip TP to be inspected through the opening area. The probes 4a protruding toward the opening area are installed in the probe card 4. Further, a microphone M is installed near the opening area. By detecting a sound wave around the chip TP by the microphone M, the test sound wave outputted from the speaker 11 is controlled so that the sound wave applied to the chip TP has a desired frequency component or a sound pressure.

The speaker 11 outputs the test sound wave in response to a test instruction sent to the probe card 4. As a result, for example, the movable section 16a of the triple-axis acceleration sensor 16 is moved, so that it becomes possible to detect an electric signal according to the movement of the movable section 16a from an inspection electrode via the probe 4a which is electrically connected with the inspection electrode by a fritting phenomenon. It is also possible to perform a device inspection by measuring this signal by the probe control unit 13 and analyzing it by the inspection control unit 2.

Here, there has been explained a case in which the probe card 4 uses the speaker 11 outputting the test sound wave, but it is not restricted thereto. It is possible to perform a desired inspection (test), if necessary, by a moving means, for example, a vibrator capable of moving the movable section 16a of the triple-axis acceleration sensor 16.

FIG. 10 is a cross-sectional view showing a structure for holding a substrate in the inspecting apparatus in accordance with an embodiment of the present invention. Though a plurality of acceleration sensors 16 are actually provided on the wafer 8, only one acceleration sensor 16 is shown in FIG. 10 for the simplicity of explanation.

The wafer 8 is mounted on a chuck top 9 of a vacuum chuck. The vacuum chuck has vacuum grooves 91 in a top surface of the chuck top 9. The vacuum grooves 91 are connected with a vacuum chamber (not shown) by a connecting pipe passing though the inside of the chuck top 9 so that a gas therein is sucked, and the wafer 8 is adsorbed and held on the chuck top 9 by a negative pressure of the vacuum grooves 91.

As described above, the acceleration sensor 16 of the wafer 8 includes the movable section 16a in which both sides of the weight body AR are supported by the beams BM. The piezoresistive devices R are installed on the beams BM, and each piezoresistive device R outputs a signal according to a distortion due to a strain of each beam BM. The probe 4a is brought into contact with the electrode of the acceleration sensor 16, and the probe 4a outputs the signal of the piezoresistive device R to the outside. The speaker 11 is disposed above the probe card 4 to apply the test sound wave to the movable section 16a.

FIG. 11 offers a cross-sectional view showing the wafer 8 which is deformed to be convexly curved upward. The top surface of the chuck top 9 has a spherical surface formed into a convexly curved shape having a nearly uniform curvature radius. For this reason, the wafer 8 adsorbed and held on the chuck top 9 is formed into a convexly curved shape. In FIG. 11, the curvature radius of the convexly curved shape is exaggeratively illustrated.

If the wafer 8 is convexly curved upward, a tension is applied on the top surface of the wafer 8 and a tensile stress is generated in the beams. For this reason, it is difficult to strain the movable section 16a and the resonant frequency becomes high. A level of an output signal of the acceleration sensor 16 becomes low and the resonant frequency becomes high. At this time, contrary thereto, a compressive stress is applied onto the lower surface of the wafer 8.

In the present embodiment, though the top surface of the chuck top 9 is assumed to have a spherical shape, any shape will be good if the tension is applied onto the both sides supporting structure considered by the inspection device. For example, if the tension needs to be applied onto only the both sides supporting structure in right and left directions in FIG. 11, the top surface of the chuck top 9 can be a cylindrical surface.

FIG. 12 illustrates a cross-sectional view of the wafer 8 which is deformed to be concavely curved upward. The top surface of the chuck top 9 has a spherical surface formed into a concavely curved shape having a nearly uniform curvature radius. For this reason, the wafer 8 adsorbed and held on the chuck top 9 is formed into a concavely curved shape. In FIG. 12, the curvature radius of the concavely curved surface is exaggeratively illustrated.

If the wafer 8 is concavely curved upward, the top surface of the wafer 8 becomes compressed and a compressive stress is generated in the beams BM. For this reason, the movable section 16a is easily strained and the resonant frequency becomes low. The level of an output signal of the acceleration sensor 16 becomes high and the resonant frequency becomes low. At this time, contrary thereto, a tensile stress is applied on the lower surface of the wafer 8.

In the present embodiment, though the top surface of the chuck top 9 is assumed to have a spherical shape, any shape will be good if the compressive stress is applied onto the both sides supporting structure considered by the inspection device. For example, if the compressive stress needs to be applied onto only the both sides supporting structure in right and left directions in FIG. 12, the top surface of the chuck top 9 can be a cylindrical surface.

It is desirable that throughout the entire surface of the chuck top 9, the curvature radius is as uniform as possible. It is desirable to make the curvature radius uniform such that the stress applied onto each chip TP formed on the wafer 8 becomes uniform enough to be within an error range of the measurement system.

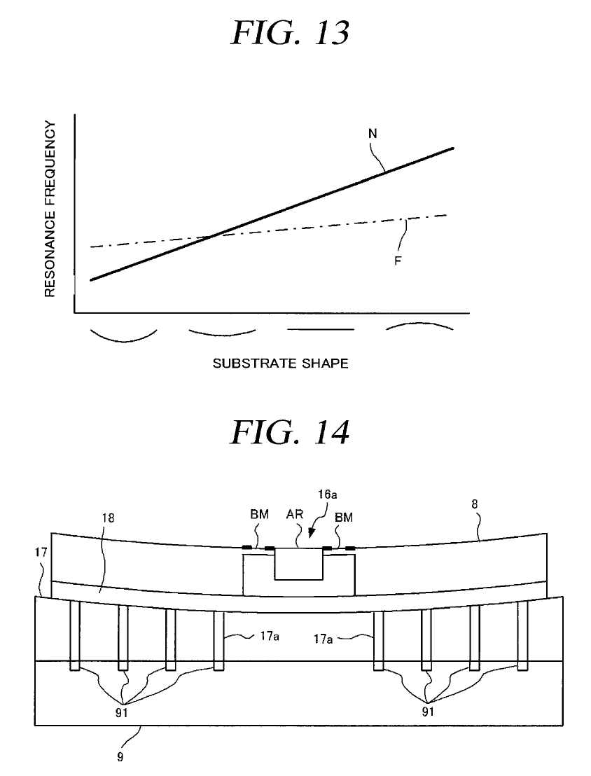

FIG. 13 is a graph showing a relationship between a substrate (wafer 8) shape and the resonant frequency of the acceleration sensor 16. A horizontal axis of FIG. 13 represents the substrate shape and shows that as it goes to the right, (the absolute value of) the curvature radius of the convexly curved shape becomes small, and as it goes to the left, the curvature radius of the concavely curved shape becomes small. The substrate shape shown in a straight line means that the wafer 8 is flat (curvature radius=infinity (∞)). If the curvature of the concavely curved shape is set to be positive, the curvature is changed from positive to negative as it goes toward the right direction in FIG. 13.

In case the acceleration sensor 16 is normal, as expressed in a solid line (marked N) in FIG. 13, as the substrate shape is changed from the concavely curved shape having a low curvature radius to the convexly curved shape, the resonant frequency of the movable section 16a becomes high. In case the movable section 16a has any abnormality, the variation in the resonant frequency is different from that of the normal case. For example, as expressed in a dashed dotted line (marked F) in FIG. 13, the variation in the resonant frequency is smaller than that of the normal case. Therefore, it is possible to determine whether the movable section 16a is normally formed or not by inspecting the variation in the resonant frequency incurred while the substrate shape is changed from the concavely curved shape to the convexly curved shape.

By varying the temperature of the chuck top 9, the shape of the top surface thereof can be changed. The chuck top 9 is formed by grinding a die-cast material such as aluminum or the like. If the top surface of the chuck top 9 is in a concavely curved shape when the temperature thereof is low, as the temperature is increased, the curvature radius becomes high and the shape of the top surface is changed to a flat shape and gradually to a convexly curved shape. By using the variation according to the temperature of the chuck top 9, it is possible to perform the inspection under different conditions of the resonant frequency as illustrated in FIG. 13.

In addition to the use of the variation according to the temperature of the chuck top 9, it is also possible to change the substrate shape from the concavely curved shape to the convexly curved shape by replacing the chuck top 9 with one of plural chuck tops 9 having different shapes. In particular, if it is necessary to keep the temperature of a target object to be inspected uniform, it is desirable to replace the chuck top 9.

Further, as a wafer holding apparatus, an electrostatic chuck for adsorbing and holding the wafer 8 by an electrostatic force or a Bernoulli chuck for adsorbing and holding the wafer 8 by the operation of fluid can be used besides the vacuum chuck.

In the first embodiment, though the acceleration sensor 16 has been described as an example, the inspecting apparatus of the present invention can be applied to the microstructure including the movable section 16a whose both sides are supported. Here, as stated above, the both sides supporting structure refers to a structure for supporting the movable section 16a at both points with respect to the center of the movable section 16a on a line passing through nearly the center of the movable section 16a. The acceleration sensor 16 of FIG. 4 has the both sides supporting structure in the X and Y-axis directions, but it is possible to apply the present invention to the structure having the points at both sides in either one of X and Y-axis directions.

If the substrate shape is in a nearly spherical surface having a concavely or convexly curved shape, a compressive stress or tensile stress is applied uniformly onto the microstructure formed on the substrate in the circumferential direction. Therefore, the inspection can be carried out under the same stress conditions regardless of the direction of the points of the both sides supporting structure in the microstructure. Further, the present invention can be applied to a case in which the both sides supporting structure is a structure having plural directions like the acceleration sensor 16 or a structure having consecutive points therearound.

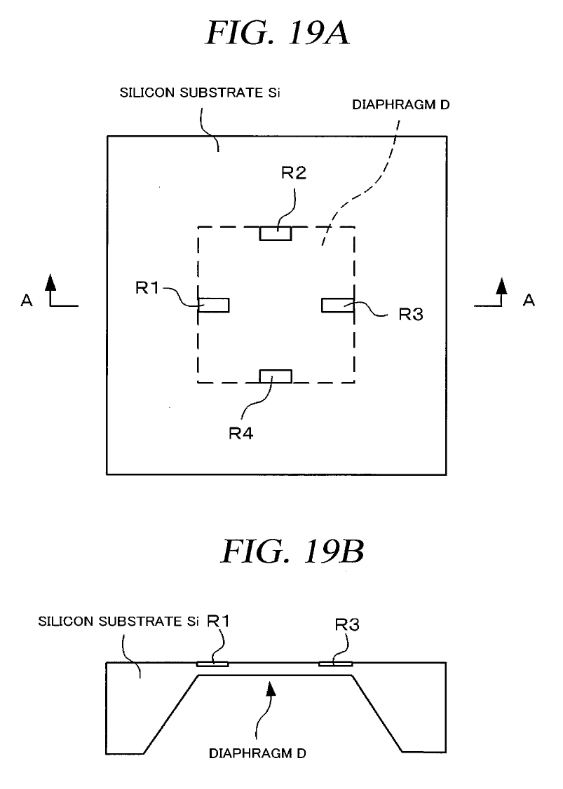

For example, the present invention can be applied to a film-structured movable section of a pressure sensor or the like. FIGS. 19A and 19B provide schematic conceptual configuration views to describe an example of a pressure sensor. FIG. 19A is a plane view of the pressure sensor, and FIG. 19B is a cross-sectional view taken along a line A-A of FIG. 19A.

As illustrated in FIGS. 19A and 19B, a substantially square diaphragm D having a thin thickness is installed in a central portion of a silicon substrate Si. Piezoresistive devices R1 to R4 are provided at centers of four sides of the diaphragm D, respectively. If the diaphragm D is strained due to a pressure difference between both sides of the diaphragm D, stresses are generated in the piezoresistive devices R1 to R4. Since electric resistance values of the piezoresistive devices R1 to F4 are varied due to the stresses, the pressure difference between both sides of the diaphragm D can be measured by detecting the variation.

As for the pressure sensor, a response of the pressure sensor can be measured by applying the compressive tensile stress on the movable section in the state the pressure sensor is formed on the substrate (e.g., on the wafer 8) in accordance with the method of the present invention. As can be seen from the cross-sectional view of FIG. 19B, when the wafer on which the diaphragm D is formed is deformed to have a concavely curved shape, the diaphragm D can be strained easily and the resonant frequency becomes low because the compressive stress is applied onto the diaphragm D. Contrary to this, when the wafer 8 is deformed to have a convexly curved shape, it is difficult to strain the diaphragm D and the resonant frequency becomes high because the tensile stress is applied onto the diaphragm D.

As stated above, a large amount of the electric variation according to the displacement of the movable section 16a of the microstructure can be obtained by applying a compressive stress onto the both sides supporting structure by changing the substrate shape. Therefore, it is possible to perform the test with high accuracy and also possible to improve an S/N ratio. Further, the inspection on the microstructure can be carried out in greater detail than a case under a single resonant frequency condition by intentionally changing the resonant frequency of the movable section 16a by varying the substrate shape from the concavely curved shape to the convexly curved shape, or by performing the test without a resonance. Therefore, the accuracy of the inspection can be enhanced.

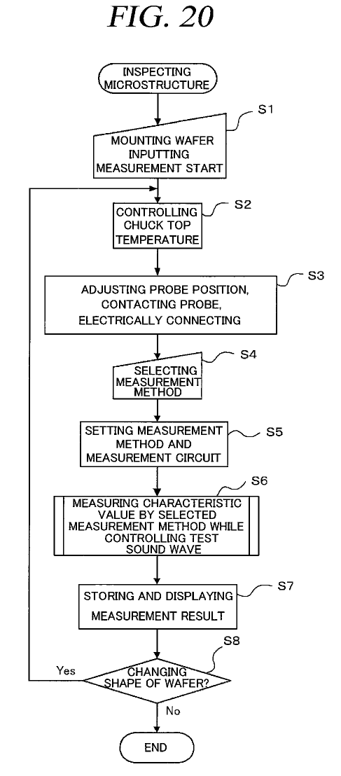

Hereinafter, an inspection method of the microstructure in accordance with the first embodiment of the present invention will be explained. FIG. 20 is a flowchart to describe an example operation of the inspecting apparatus 1 in accordance with the embodiment of the present invention. Further, the operation of the inspection control unit 2 is performed by operating the controller 21 together with the main storage unit 22, the external storage unit 23, the input unit 24, the input/output unit 25 and the display unit 26.

The inspection control unit 2 waits for a measurement start instruction to be inputted after the wafer 8 is mounted on the main chuck 14 (step S1). When the measurement start instruction is inputted through the input unit 24 to the controller 21, the controller 21 instructs the chuck top temperature control unit 3 through the input/output unit 25 to control the temperature of the chuck top 9 to be a predetermined temperature (step S2).

When the temperature (shape) of the chuck top 9 becomes the predetermined temperature (shape), the probe control unit 13 is instructed to adjust a position of the probe 4a to be brought into contact with the electrode pad PD of the wafer 8 (step S3). Then, the probe control unit 13 is instructed to electrically connect the probe 4a with the electrode pad PD by the fritting circuit 5 (step S3).

In the present embodiment, though the contact resistance between the electrode pad PD and the probe 4a is reduced by using the fritting phenomenon, any method other than the fritting method can also be employed as a method for allowing the electric conduction by reducing the contact resistance. For example, it is possible to use a method including: transmitting an ultrasonic wave to the probe 4a; partially destroying the oxide film on the surface of the electrode pad PD; and reducing the contact resistance between the electrode pad PD and the probe 4a.

Subsequently, a selection of a measurement method is inputted (step S4). The measurement method can be pre-stored in the external storage unit 23 and can be inputted through the input unit 24 each time the measurement is taken. Upon the measurement method is inputted, a measurement circuit used for the inputted measurement method and a frequency and a sound pressure of a test sound wave applied to the movable section 16a are set (step S5).

The measurement methods to be selected include, for example, a frequency sweeping inspection (frequency scan) for inspecting a response at each frequency by successively varying the frequency of the sound wave, a white noise inspection for inspecting a response by applying a pseudo white noise within a preset frequency range, a linearity inspection for inspecting a response by varying the sound pressure while fixing the frequency at a certain value, and so forth.

Then, by employing the selected measurement method, an electric signal, i.e., a response of the acceleration sensor 16 is detected from the probes 4a while displacing the movable section 16a of the acceleration sensor 16 by controlling the speaker control unit 10, so that a response characteristic of the acceleration sensor 16 is inspected (step S6). Then, a detected measurement result is stored in the external storage unit 23 and displayed on the display unit 26 (step S7).

Further, in case of inspecting the characteristics by varying the shape of the wafer 8 (step S8; Yes), a setting temperature of the chuck top 9 is changed and the chuck top temperature control unit 3 is instructed to control the temperature of the chuck top 9 at the preset temperature (step S2). Then, the operations from step S3 to step S7 are iterated to perform the inspection on the wafer 8 while changing the shape of the wafer 8 to have a different curvature radius. If any further change in the shape of the wafer 8 is not necessary (step S8; No), the inspection comes to an end.

Further, the shape of the wafer 8 can be changed by replacing the chuck top 9 and by adsorbing and holding the wafer 8 again in step S2.

### First Modification Example of the First Embodiment

FIG. 14 presents a cross-sectional view showing a configuration example of using a tray in a structure for holding a wafer 8. In the example shown in FIG. 14, the tray 17 is placed between the wafer 8 and a chuck top 9. In this case, the shape of the chuck top 9 is not changed and the surface thereof is formed into, e.g., a flat shape, matched with the lower surface of the tray 17. In order to make the shape of the wafer 8 into a convexly or concavely curved shape having a uniform curvature radius, the top surface of the tray 17 is formed into a convexly or concavely curved shape. FIG. 14 shows that the top surface of the tray 17 is formed into a concavely curved shape. On the lower surface of the wafer 8, e.g., a glass planar substrate 18 is attached. The shape of the planar substrate 18 is changed together with the wafer 8.

Connecting pipes 17a are installed in the tray 17 to be matched with the vacuum grooves 91 of the chuck top 9. The connecting pipes 17a are, for example, configured as vacuum grooves and arranged on a concentric circle in the top surface of the tray 17. The vacuum grooves in the top surface of the tray 17 are sucked through the connecting pipes 17a to the vacuum grooves 91 in the top surface of the chuck top 9 so that the pressure thereof becomes negative. As a result, the wafer 8 is adsorbed and held on the surface of the tray 17.

In case of using the tray 17, the shape of the wafer 8 can be changed to a concavely or convexly curved shape by replacing it with another tray 17 in a different shape. It is easier to replace the tray 17 than to replace the chuck top 9 because it is only necessary to adjust the positions of the vacuum grooves 91 and the connecting pipes 17a.

If the vacuum grooves 91 are contacted directly onto the lower surface of the wafer 8 and are under the movable section 16a of the acceleration sensor 16, the movable section 16a is adsorbed since the lower portion of the movable section 16a is a hollow. Otherwise, since a gas is adsorbed through a gap between the beams BM of the movable section 16a, the pressure for adsorbing and holding the wafer 8 becomes lower. However, by attaching the planar substrate 18 onto the lower surface of the wafer 8, the movable section 16a is not adsorbed but the adsorptive force is maintained even if the positions of the vacuum grooves 91 are matched with those of the movable section 16a of the acceleration sensor 16.

Further, the planar substrate 18 is effective even if the tray 17 is not used. When the planar substrate 18 is not used, the vacuum grooves 91 should be arranged not to correspond to the movable section 16a, but if the planar substrate 18 is installed on the lower surface of the wafer 8, it is not necessary to set the positions of the vacuum grooves 91 to avoid a position of the movable section 16a. The same chuck top 9 can be used with respect to the wafer 8 having another microstructure.

### Second Modification Example of the First Embodiment

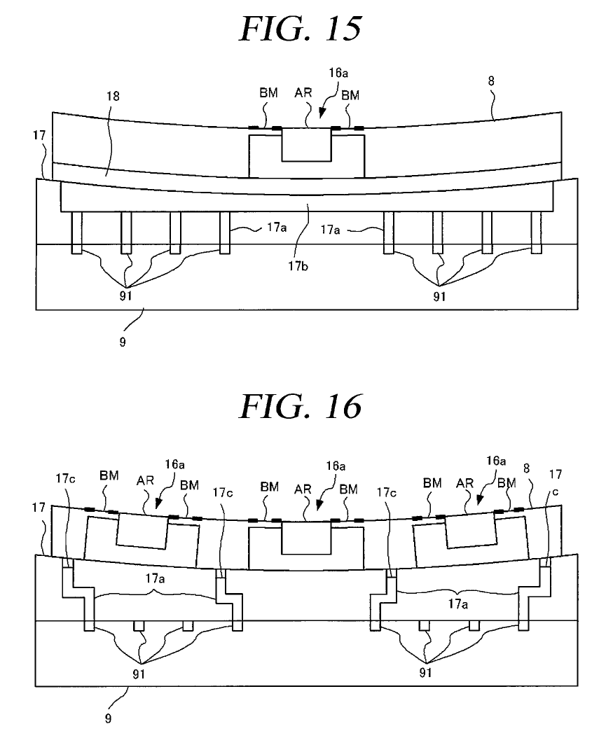

FIG. 15 depicts a structure for holing a wafer 8 in accordance with the second modification example of the first embodiment of the present invention. The tray 17 illustrated in FIG. 15 includes a high porosity layer 17b in a portion attached to the wafer 8 thereabove. In FIG. 15, e.g., the glass planar substrate 18 is attached onto the lower surface of the wafer 8. The shape of the planar substrate 18 is changed together with the wafer 8.

Openings of the connecting pipes 17a are in contact with a lower surface of the high porosity layer 17b. The connecting pipes 17a are connected with the vacuum grooves 91 in the chuck top 9. A gas in a top surface of the high porosity layer 17b is sucked through the high porosity layer 17b and the connecting pipes 17a into the vacuum grooves 91 of the chuck top 9. Accordingly, the wafer 8 is adsorbed and held onto the surface of the tray 17. By using the high porosity layer 17b in the top surface of the tray 17, it is possible to adsorb and hold the entire lower surface of the wafer 8 with a uniform pressure.

Further, in case of the microstructure having the movable section 16a with its both sides supported, if the rear surface of the wafer 8 in which the microstructure is formed is airtight so that the suction of the vacuum adsorption does not have any effect on the movable section 16a, the glass planar substrate 18 is not needed to be attached to the wafer 8. Further, if the high porosity layer 17b is formed only in a portion not corresponding to the movable section 16a of the acceleration sensor 16, it is not necessary to attach the planar substrate 18 to the wafer 8 even if the bottom of the movable section 16a of the wafer 8 is opened.

Further, it may be possible to form the top surface of the chuck top 9 into a concavely or convexly curved shape and form the high porosity layer 17b on the surface thereof without using the tray 17. In this case, if the high porosity layer 17b is formed in a portion not corresponding to the movable section 16a of the acceleration sensor 16, it is not necessary to attach the planar substrate 18 to the wafer 8 even if the bottom of the movable section 16a of the wafer 8 is opened. Further, in the configuration illustrated in FIG. 15, it may be possible to form the high porosity layer 17b on the top surface of the chuck top 9 instead of the vacuum grooves 91 on the top surface of the chuck top 9. In this case, a gas on the top surface of the tray 17 is sucked via the high porosity layer 17b, the connecting pipes 17a and the high porosity layer 17b on the top surface of the chuck top 9.

### Third Modification Example of the First Embodiment

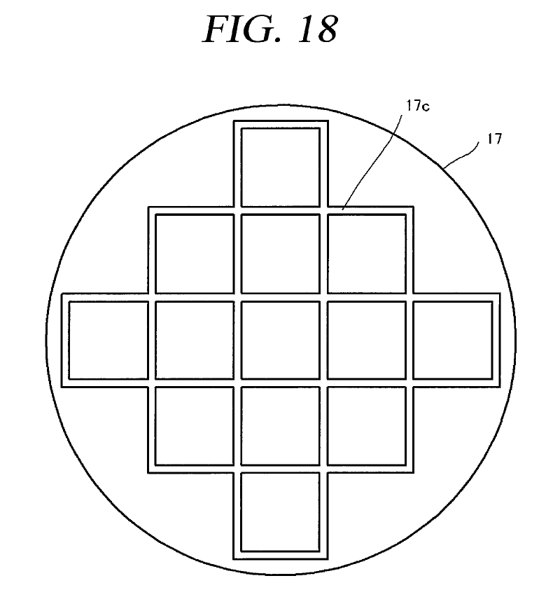

FIGS. 16 to 18 illustrate a structure for holding a wafer 8 in accordance with the third modification example of the first embodiment of the present invention. A vacuum groove 17c is formed in the top surface of the tray 17 (see FIG. 18). As shown in FIG. 16, connecting pipes 17a are formed on the tray 17 so as to connect the vacuum grooves 17c on the top surface of the tray 17 and the vacuum grooves 91 on the chuck top 9.

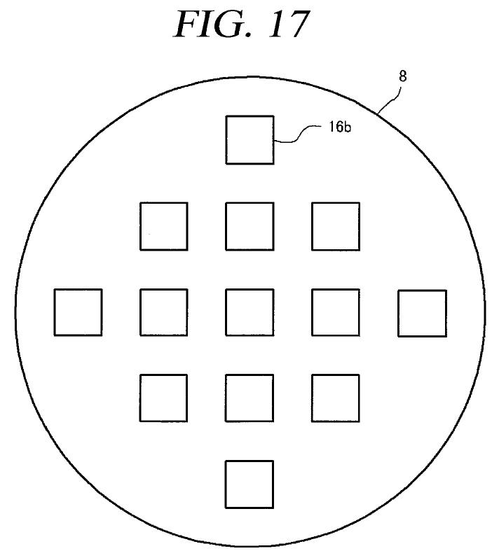

FIG. 17 shows an example position of hollow portions 16b of a wafer 8. FIG. 18 shows an example shape of the vacuum groove 17c on the top surface of the tray 17. As illustrated in FIG. 17 and FIG. 18, the vacuum groove 17c on the top surface of the tray 17 is formed to be in contact with a portion other than the hollow portions 16b of the wafer 8.

By forming the vacuum groove 17c of the tray 17 to be in contact with the portion other than the hollow portions 16b of the wafer 8, it is not necessary to attach the planar substrate 18 to the wafer 8. Further, by preparing a tray 17 having a vacuum groove 17c according to a hollow portion 16b of a wafer 8 having a pattern in which a position of a microstructure is different, it is not necessary to replace the chuck top 9 for each wafer 8 having a different pattern.

Furthermore, in the configuration of FIG. 16, it may be possible to form a high porosity layer 17b on the top surface of the chuck top 9 instead of forming the vacuum grooves 91 on the top surface of the chuck top 9. Even if the vacuum grooves 17c of the tray 17 has a different pattern, since it is desirable to form the connecting pipes 17a in a straight form, it becomes easy to manufacture the tray 17.

Further, in the first to third modification examples, it is also possible to vary the shape of the top surface of the tray 17 into a concavely or convexly curved shape by controlling the temperature of the tray 17.

### EXAMPLES

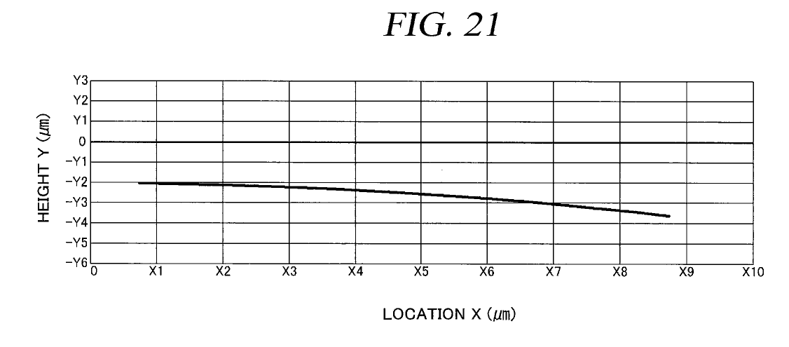

FIGS. 21 to 24 provide a measurement result of a response of the acceleration sensor 16 by changing the shape of the wafer 8 into a convexly or concavely curved shape.

FIG. 21 illustrates a cross sectional shape of the chuck top 9 when the wafer 8 is convexly curved upward. In FIG. 21, scales of a position x and a height y are shown differently and the height y is exaggerated with respect to the position x. In FIG. 21, the cross section of the chuck top is slanted as a whole but has a nearly uniform curvature radius. The absolute value of the curvature radius is more than 1000 m.

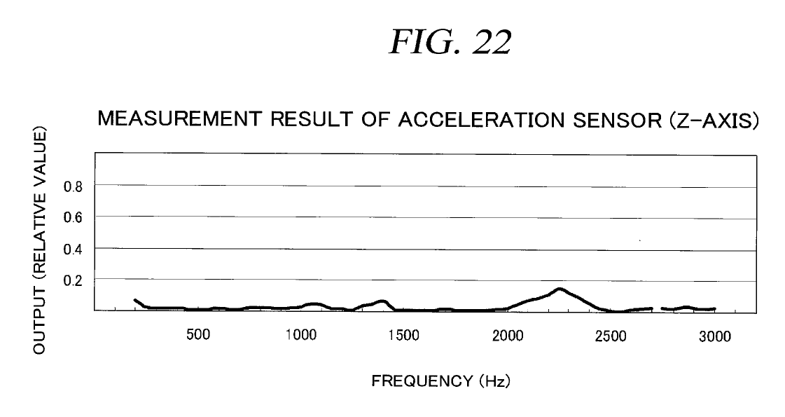

FIG. 22 provides a measurement result of a response of the acceleration sensor 16 when the wafer 8 is adsorbed by using the chuck top 9 of FIG. 21. The application of the vibration to the acceleration sensor 16 is performed by the incidence of the test sound wave of about 200 to 3000 Hz and the change in the piezoresistance values is measured as an electrical change. The output is the measurement result in FIG. 22 and a normalized relative value. In view of the film formation structure of the wafer 8, since the beam in which the piezoresistance device R is placed is strained by a strong tensile stress, the resonance is acknowledged as about 2300 Hz even though the vibration amplitude of the movable section 16a is small.

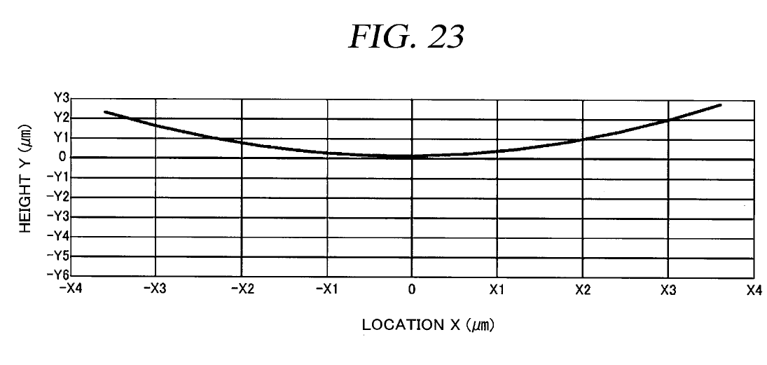

FIG. 23 illustrates a cross sectional shape of the chuck top 9 when the wafer 8 is concavely curved upward. In FIG. 23, too, scales of a position x and a height y are shown differently and the height y is exaggerated with respect to the position x. In FIG. 23, the cross section of the chuck top has a nearly uniform curvature radius and the curvature radius is more than 1000 m.

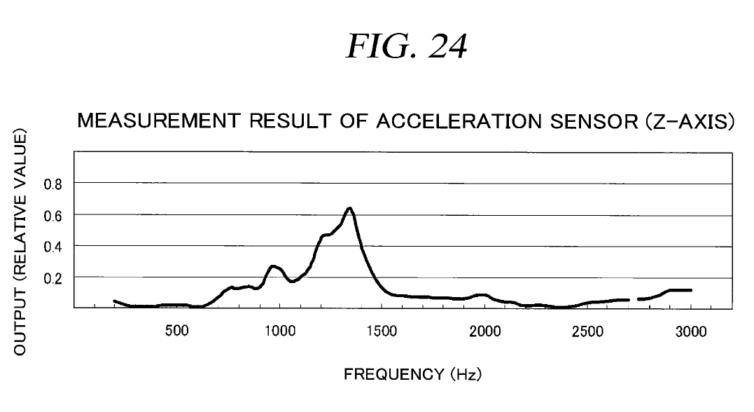

FIG. 24 provides a measurement result of a response of the acceleration sensor 16 when the wafer 8 is adsorbed by using the chuck top 9 of FIG. 23. The conditions for the measurement are the same as those in the case shown in FIG. 22. The output is a relative value. Since the chuck top 9 has a shape convexly curved downward, the tensile force of the beam is reduced and it becomes easy for the movable section 16a to vibrate. For this reason, the resonant frequency is changed to about 1400 Hz in comparison with that of the case shown in FIG. 22 and the displacement of the movable section 16a becomes larger. Accordingly, it can be seen that the S/N ratio of the measured data becomes improved and the test has been taken under the desirable conditions.

In addition, by testing the wafer 8 while changing the curvature radius of its concavely curved shape, the response can be inspected by changing the resonant frequency of the structure. Further, contrary to this, it is possible to confirm that there is no output by performing an inspection on the chuck top having a convexly curved shape. For example, in case there is a problem such as a short wiring, a disconnection of the wiring or a partially poor film formation in the measured device, a certain output can be found. By measuring the response of the movable section 16a with its both sides supported while maintaining the wafer 8 in a concavely or convexly curved shape having a nearly uniform curvature radius, it is possible to improve accuracy of the determination of success or failure in the inspection in a wafer state.

Besides, it should be noted that the above-described hardware configurations or the flowcharts are nothing more than examples, so they can be changed or modified in various ways.

The inspection controller of the inspecting apparatus 1 can be realized by using a typical computer system instead of using a dedicated system. For example, it may be possible to implement the inspection control unit 2 for performing the above-described processes by storing a computer program for performing the above-described operations in a computer-readable storage medium (a flexible medium, CD-ROM, DVD-ROM, etc.); distributing the computer program and installing the computer program on a computer. In addition, it is also possible to implement the inspection control unit 2 of the present invention by storing the computer program in a storage device of a server over a communication network such as the Internet, or the like and downloading the computer program through a typical computer system.

Further, if each of the above-described functions is implemented by a task share between an operating system (OS) and an application program or a cooperation of the OS and the application program, only the application program may be stored in a storage medium or a storage device.

Besides, the above-described computer program can be transmitted by a data signal embodied in a carrier wave over a communication network.

It is clear that the above-described embodiments are illustrative in all aspects and do not limit the present invention. The scope of the present invention is defined by the following claims rather than by the detailed description of the embodiment, and it shall be understood that all modifications and embodiments conceived from the meaning and scope of the claims and their equivalents are included in the scope of the present invention.

The present application claims the benefit of Japanese Patent Application Ser. No. 2006-299485, filed on Nov. 2, 2006, of which specification, claims and drawings are hereby incorporated by reference in its entirety.

### INDUSTRIAL APPLICABILITY

The present invention can be used in an apparatus for inspecting a microstructure such as a MEMS.

What is claimed is:

1. An inspecting apparatus of a microstructure having a movable section with its both sides supported, the apparatus comprising:
a substrate holding unit for holding a substrate in which the microstructure is formed so as to make a main surface of the substrate into a convexly or concavely curved shape having a nearly uniform curvature radius.

2. The microstructure inspecting apparatus of claim 1, further comprising:
a shape changing unit for changing the curvature radius of the shape of the main surface of the substrate.

3. The microstructure inspecting apparatus of claim 2, wherein the shape changing unit is a temperature controlling unit for changing a shape of a top surface of a chuck top, on which the substrate is mounted, according to a temperature.

4. The microstructure inspecting apparatus of claim 1, wherein the substrate holding unit includes a chuck top whose top surface, on which the substrate is mounted, is formed into a convexly or concavely curved shape.

5. The microstructure inspecting apparatus of claim 1, wherein the substrate holding unit includes a transfer tray whose top surface, on which the substrate is mounted, is formed into a convexly or concavely curved shape.

6. A method for inspecting a microstructure having a movable section with its both sides supported, the method comprising:
measuring characteristics of the microstructure while maintaining a substrate so as to make a main surface of the substrate, in which the microstructure is formed, into a convexly or concavely curved shape having a nearly uniform curvature radius.

7. The microstructure inspecting method of claim 6, further comprising:
changing the curvature radius of the shape of the main surface of the substrate.

8. The microstructure inspecting method of claim 6, further comprising:
adsorbing and holding the substrate on a chuck top whose top surface, on which the substrate is mounted, is formed into a convexly or concavely curved shape.

9. The microstructure inspecting method of claim 6, wherein a transfer tray whose top surface, on which the substrate is mounted, is formed into a convexly or concavely curved shape is interposed between the substrate and the chuck top so as to adsorb and hold the substrate.

10. A substrate holding apparatus for holding a substrate, in which a microstructure having a movable section with its both sides supported is formed, so as to make a main surface of the substrate into a convexly or concavely curved shape having a nearly uniform curvature radius.

11. The substrate holding apparatus of claim 10, comprising:
a shape changing unit for changing the curvature radius of the shape of the main surface of the substrate.

12. The substrate holding apparatus of claim 10, wherein the substrate holding apparatus is a chuck top whose top surface, on which the substrate is mounted, is formed into a convexly or concavely curved shape.

13. The substrate holding apparatus of claim 12, wherein the substrate holding apparatus holds the substrate by a vacuum-adsorption; and a vacuum-adsorbing groove formed on the top surface of the chuck top on which the substrate is mounted is formed to be contact with a portion not corresponding to the movable section of the microstructure of the substrate.

14. The substrate holding apparatus of claim 12, wherein the substrate holding apparatus holds the substrate by a vacuum-adsorption; and a high porosity layer is formed on the top surface of the chuck top on which the substrate is mounted.

15. The substrate holding apparatus of claim 12, wherein the substrate holding apparatus holds the substrate by a vacuum-adsorption; and a high porosity layer is formed on the top surface of the chuck top on which the substrate is mounted to be in contact with a portion not corresponding to the movable section of the microstructure of the substrate.

16. The substrate holding apparatus of claim 10, wherein the substrate holding apparatus includes a transfer tray whose top surface, on which the substrate is mounted, is formed into a convexly or concavely curved shape.

17. The substrate holding apparatus of claim 16, wherein the substrate holding apparatus holds the substrate by a vacuum-adsorption; and a vacuum-adsorbing groove formed on the top surface of the transfer tray on which the substrate is mounted is formed to be contact with a portion not corresponding to the movable section of the microstructure of the substrate.

18. The substrate holding apparatus of claim 16, wherein the substrate holding apparatus holds the substrate by a vacuum-adsorption; and a high porosity layer is formed on the top surface of the transfer tray on which the substrate is mounted.

19. The substrate holding apparatus of claim 16, wherein the substrate holding apparatus holds the substrate by a vacuum-adsorption; and a high porosity layer is formed on the top surface of the transfer tray on which the substrate is mounted so as to be in contact with a portion not corresponding to the movable section of the microstructure of the substrate.
